(19) United States
(12) Patent Application Publication
(10) Pub. No.: US 2014/0036927 A1
(43) Pub. Date: Feb. 6, 2014

(54) FORCE PROTECTION SWITCHING METHOD IN ETHERNET RING NETWORK

(71) Applicant: Electronics And Telecommunications Research Institute, Daejeon-City (KR)

(72) Inventors: Do Yeon KIM, Daejeon-City (KR); Tae Sik CHEUNG, Daejeon-City (KR); Byung Jun AHN, Daejeon-City (KR); Bong Tae KIM, Daejeon-City (KR)

(73) Assignee: Electronics And Telecommunications Research Institute, Daejeon-City (KR)

(21) Appl. No.: 14/054,092

(22) Filed: Oct. 15, 2013

Related U.S. Application Data
(63) Continuation of application No. 12/988,855, filed on Oct. 21, 2010.
(60) Provisional application No. 61/046,829, filed on Apr. 22, 2008.

(30) Foreign Application Priority Data
Dec. 19, 2008 (KR) 10-2008-0130444
Apr. 10, 2009 (KR) 12-2009-0031258

(51) Int. Cl. H04L 12/707

(52) U.S. Cl. CPC H04L 45/22
USPC 370/406

(57) ABSTRACT

Provided are a forced protection switching method and a forced protection switching clearing method in an Ethernet ring network. When an operator desires to block a port of a specific node for maintenance and repair, the operator gives a forced switching (FS) command to the specific node in order to block the port. When the operator desires to clear FS, the operator gives a clear command to the specific node in order to clear the blocked port. As a result, operation flexibility of the Ethernet ring network is provided.

### TECHNICAL FIELD

The present invention relates to a forced protection switching method and a forced protection switching clearing method in an Ethernet ring network.

### BACKGROUND ART

Due to an increase in Internet users, the rate at which traffic in a communication network has increased is high. Also, Internet users have demanded various types of services, such as a high-speed data service, an electronic commerce (e-commerce) transaction service, a telemedicine service, a virtual education service, and a real-time is multimedia service.

Therefore, a management scheme of coping with a communication network that is malfunctioning or performing poorly is required to provide users with continuous services and to maximize efficiency of the communication network.

Methods of improving the survivability of a management scheme are mostly classified into protection switching and restoration. Protection switching refers to a method of rapidly restoring the communication network by presetting both a path and a bandwidth between nodes when faults in the communication network occur. Restoration refers to a method of restoring interrupted services to their original states using both available paths and a volume of the communication network after the faults in the communication network occur.

In more detail, protection switching is a technique that has been applied mainly to optical transmission equipment, such as synchronous digital hierarchy (SDH)/synchronous optical network (SONET).

A conventional Ethernet protection switching technique is to block a specific port when operating normally and to unblock the specific port when a fault is detected. Thus, an operator is not able to easily block a link that is temporarily operating to repair a transmission line of a specific node in an Ethernet ring network.

### DETAILED DESCRIPTION OF THE INVENTION

### Technical Problem

The present invention provides a forced protection switching method and a forced protection switching clearing method in an Ethernet ring network to assist an operator to easily block and clear a link corresponding to a specific node so as to provide usefulness of the Ethernet ring network.

### Technical Solution

According to an aspect of the present invention, there is provided a forced protection switching method applied in a node of an Ethernet ring network, including: receiving a forced switching (FS) command; blocking a port of a corresponding; forwarding a FS message indicating that the Ethernet ring network is forcedly switched; and flushing a filtering database (FDB).

According to another aspect of the present invention, there is provided a forced protection switching method applied in a node of an Ethernet ring network whose port is linked to an ring protection link (RPL) of the Ethernet ring network and is blocked, including: receiving a FS message indicating that the Ethernet ring network is forcedly switched; clearing the blocked port linked to the RPL; and flushing an FDB. According to another aspect of the present invention, there is provided a forced protection switching method applied in a node of an Ethernet ring network, including: receiving a FS message indicating that the Ethernet ring network is forcedly switched; and flushing an FDB.

According to another aspect of the present invention, there is provided a forced protection switching clearing method applied in a node of an Ethernet ring network that has been forcedly switched, including: receiving a FS clear command; driving a timer; forwarding a clear message indicating that the node has been cleared of being forcedly switched; receiving a return message indicating that a port linked to an RPL of the Ethernet ring network has been blocked, after the timer ends; clearing the blocked port of the node; and flushing an FDB.

According to another aspect of the present invention, there is provided a forced protection switching clearing method applied in a node of an Ethernet ring network whose port is linked to an RPL of the Ethernet ring network and is cleared of being blocked, including: receiving a clear message indicating that the Ethernet ring network had been cleared of being forcedly switched; driving a timer; when the timer ends, blocking the port that is linked to the RPL; forwarding a return message indicating that the port linked to the RPL has been blocked; and flushing an FDB.

According to another aspect of the present invention, there is provided a forced protection switching clearing method applied in a node of an Ethernet ring network, including: receiving a clear message indicating that the Ethernet ring network had been cleared of being forcedly switched; receiving a return message indicating that a port linked to a RPL of the Ethernet ring network has been blocked; and flushing an FDB.

### Advantageous Effects

According to the present invention, when an operator temporarily forcedly blocks a specific link for maintenance and repair, such as inspections of states of links, etc., in an Ethernet ring network, the operator can maintain services that are being provided so as to provide flexibility of the Ethernet ring network.

### DESCRIPTION OF THE DRAWINGS

FIG. 1 illustrates a forced protection switching method applied in an Ethernet ring to network, according to an embodiment of the present invention;

FIG. 2 illustrates a forced protection switching clearing method applied in an Ethernet ring network, according to an embodiment of the present invention;

FIG. 3 is a flowchart illustrating a forced protection switching method applied in a node of an Ethernet ring network that has received a forced switching (FS) command, according to an embodiment of the present invention;

FIG. 4 is a flowchart illustrating a forced protection switching method applied in a normal node of an Ethernet ring network, according to an embodiment of the present invention;

FIG. 5 is a flowchart illustrating a forced protection switching method applied in a ring protection link (RPL) Owner of an Ethernet ring network, according to an embodiment of the present invention;

FIG. 6 is a flowchart illustrating a forced protection switching clearing method applied in a node of an Ethernet ring network that has received a FS clear command, according to an embodiment of the present invention;

FIG. 7 is a flowchart illustrating a forced protection switching clearing method applied in an RPL Owner of an Ethernet ring network, according to an embodiment of the present invention; and

FIG. 8 is a flowchart illustrating a forced protection switching clearing method applied in a normal node of an Ethernet ring network, according to an embodiment of the present invention.

### MODE OF THE INVENTION

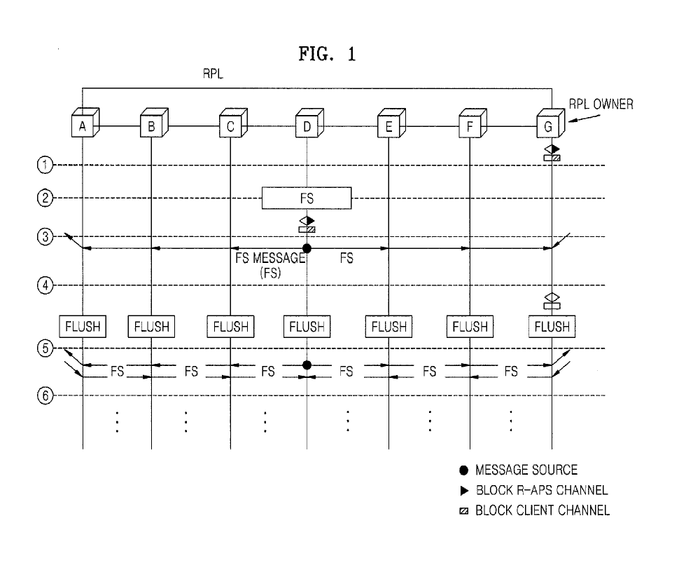

The present invention will now be described more fully with reference to the accompanying drawings, in which exemplary embodiments of the invention are shown. FIG. 1 illustrates a forced protection switching method applied in an Ethernet ring network, according to an embodiment of the present invention. Referring to FIG. 1, one (a link between nodes “A” and “G”) from a plurality of links constituting the Ethernet ring network is set as a ring protection link (RPL), and the node “G” linked to one of two ends of the RPL is designated as an RPL Owner. The RPL Owner blocks the RPL when operating normally in order to prevent a loop from being formed.

For example, when an operator gives a forced switching (FS) command to node “D” in order to block a link between nodes “D” and “E,” the node “D” blocks a port corresponding to the link between nodes “D” and “E”, bidirectionally forwards a FS message periodically, and initializes, i.e., flushes, its filtering database (FDB). Here, the FDB refers to a table that includes port numbers and node identification information, i.e., a database indicating which port a received packet is forwarded to.

When a node that is not an RPL Owner receives a FS message, the node flushes its FDB. Without a higher priority demand, when the RPL Owner receives a FS message, the RPL Owner unblocks a port blocked when the RPL Owner blocked the RPL in an initial stage, and initializes its FDB.

The node “D” bidirectionally forwards the FS message periodically so that the other nodes recognize that a ring is forcedly switched. Even if the other nodes receive the FS message from the node “D,” they do not re-initialize (re-flush) their FDBs after the first time the FS message is received. Service traffic resumes when the FDBs of the nodes are updated through a media access control (MAC) learning process.

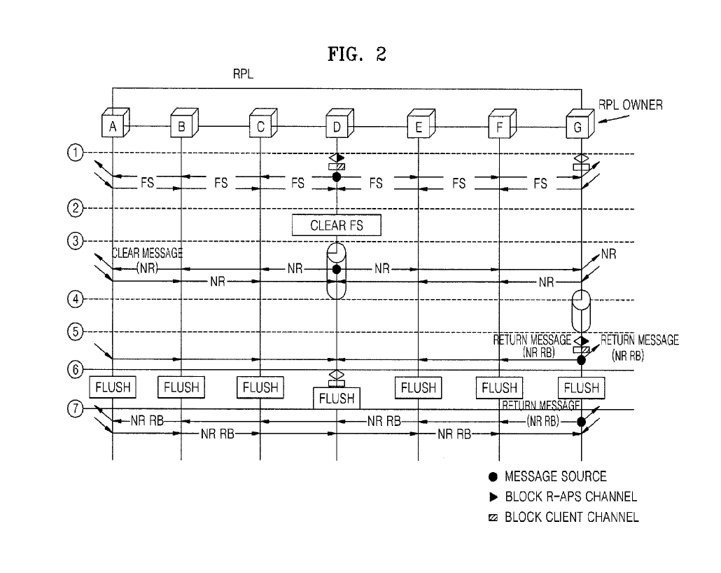

FIG. 2 illustrates a forced protection switching clearing method applied in an Ethernet ring network, according to an embodiment of the present invention. Referring to FIG. 2, an operator gives a clear command to node “D” in order to clear FS of the node “D” that is in a FS state, in which, for example, a right port of the node “D” is blocked and a blocked port of an RPL Owner is cleared.

When the node “D” receives the clear command, the node “D” drives a guard timer before flushing its FDB to prevent malfunctioning due to an unavailable FS message or return message that may be received from a neighboring node. Next, the node “D” bidirectionally forwards a clear message indicating that the clear command to clear FS has been given.

When the RPL Owner receives the clear message, the RPL Owner drives a Wait to Block (WTB) timer, and when the WTB timer expires, the RPL Owner re-blocks the port that had been unblocked and bidirectionally forwards a return message. The RPL Owner also flushes its FDB and bidirectionally forwards the return message periodically to indicate that a node of a ring is idle.

When the node “D” receives the return message, the node “D” clears the blocked right port and flushes its FDB when the guard timer expires. Even if the other nodes receive the return message, they do not re-initialize their FDBs after the first time, and service traffic resumes according to a MAC learning process.

FIG. 3 is a flowchart of a forced protection switching method applied in a node of an Ethernet ring network that has received a FS command, according to an embodiment of the present invention.

Referring to FIGS. 1 and 3, an operator inputs the FS command into a specific node (the node “D” in the case of FIG. 1) that is linked to a specific link in order to temporarily block the specific link. For convenience, the specific node that has received the FS command is referred to as the node “D” with reference to FIG. 1.

In operation S300, the node “D” receives the FS command. In operation S310, the node “D” blocks a Ring-Automatic Protection Switching (R-APS) channel and traffic from the specific link that is to be blocked. In operation S320, the node “D” bidirectionally forwards a FS message that indicates FS. In this state, the node “D” continues forwarding the FS message. In operation S330, the node “D” flushes its FDB.

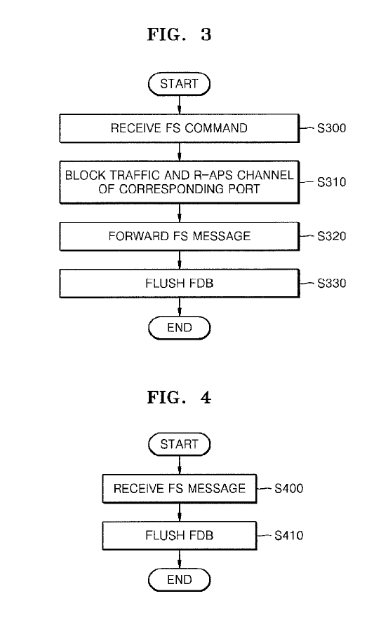

FIG. 4 is a flowchart illustrating a forced protection switching method applied in a normal node of an Ethernet ring network, according to an embodiment of the present invention.

Referring to FIGS. 1 and 4, in operation S400, the normal node receives a FS message indicating FS from the node “D”, which has received a FS command. In operation S410, the normal node flushes its FDB. The normal node periodically receives the FS message from the node “D” but does not perform any action with respect to the FS message that the normal node receives after the first time the FS message is received.

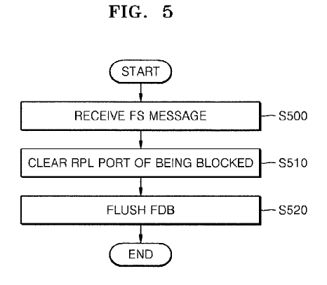

FIG. 5 is a flowchart illustrating a forced protection switching method applied in an RPL Owner of an Ethernet ring network, according to an embodiment of the present invention.

Referring to FIGS. 1 and 5, in operation S500, the RPL Owner receives a FS message indicating FS from the node “D”, which has received a FS command. In operation S510, the RPL Owner clears blocking of a blocked RPL port. In operation S520, the RPL Owner flushes its FDB. The RPL Owner periodically receives the FS message but does not perform any action with respect to the FS message that the RPL Owner receives after the first time.

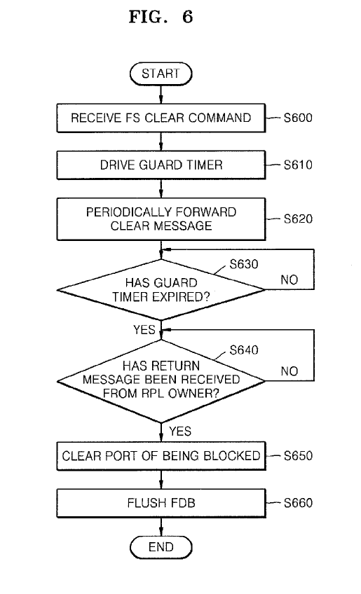

FIG. 6 is a flowchart illustrating a forced protection switching clearing method applied in a node of an Ethernet ring network that has received a FS clear command, according to an embodiment of the present invention.

Referring to FIGS. 2 and 6, in operation S600, the node “D”, which has been forcedly switched by a FS command from an operator, receives a forced protection switching clear command from the operator. In operation S610, the node “D” drives a guard timer before flushing its FDB in order to prevent unavailable R-APS messages from being received. In operation S620, the node “D” forwards a clear message that indicates that forced protection switching has been cleared bidirectionally. In this state, the node “D” continues forwarding the clear message.

In operation S630, the node “D” determines whether the guard timer has expires. If the node “D” determines in operation S630 that the guard timer has expires, in operation S640, the node “D” determines whether the node “D” has received a return message that indicates that an RPL has been blocked from the RPL Owner. If the node “D” determines in operation S640 that the node “D” has received the return message, the node “D” clears a port that had been blocked by FS, in operation S650. In operation S660, the node “D” flushes its FDB.

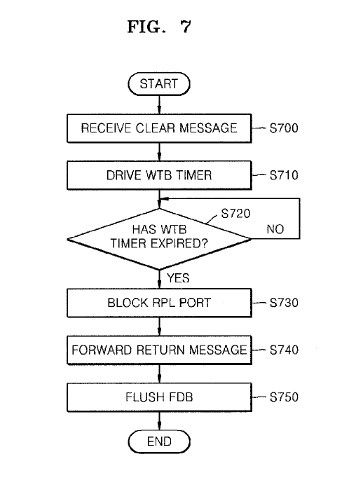

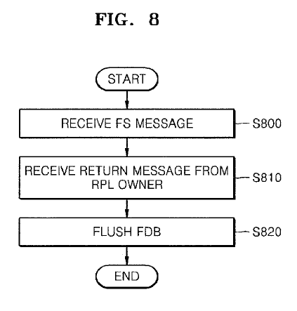

FIG. 7 is a flowchart illustrating a forced protection switching clearing method applied in an RPL Owner of an Ethernet ring network, according to an embodiment of the present invention.

Referring to FIGS. 2 and 7, in operation S700, the RPL Owner receives a clear message from the node “D.” In operation S710, the RPL Owner drives a WTB timer. In operation S720, the RPL Owner determines whether the WTB timer has expired. If the RPL Owner determines in operation S720 that the WTB timer has expired, the RPL Owner blocks a RPL port in operation S730. In operation S740, the RPL Owner bidirectionally forwards a return message indicating that the RPL port has been re-blocked. In operation S750, the RPL Owner flushes its FDB.

FIG. 8 is a flowchart illustrating a forced protection switching clearing method applied in a normal node of an Ethernet ring network according to an embodiment of the present invention.

Referring to FIGS. 2 and 8, in operation S800, the normal node receives a clear message from the node “D”, which has received a FS clear command. In operation S810, the normal node receives a return message that indicates that the Ethernet ring network has been re-blocked, i.e., has returned to its initial state from the RPL Owner. In operation S820, the normal node flushes its FDB. The normal node does not perform any action with respect to the return message that the normal node receives after the first time the message is received.

The invention can also be embodied as computer readable codes on a computer readable recording medium. The computer readable recording medium is any data storage device that can store data that can be thereafter read by a computer system. Examples of the computer readable recording medium include read-only memory

(ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A forced protection switching method applied in a node of an Ethernet ring network, comprising:
receiving a forced switching (FS) command from an operator;
blocking a port of a link as indicated in the force switching command;
forwarding bidirectionally in the Ethernet ring network, a FS message indicating that the Ethernet ring network is forcedly switched.

2. The forced protection switching method of claim 1, wherein the forwarding of the FS message comprises forwarding the FS message periodically.

3. The forced protection switching method of claim 1, wherein the blocking of the port comprises blocking traffic and an Ring-Automatic Protection Switching (R-APS) channel for a port corresponding to a blocked one of two links that are linked to the node.

4. A forced protection switching method applied in a node of an Ethernet ring network whose port is linked to an RPL (ring protection link) of the Ethernet ring network and is blocked, comprising:
receiving a FS message indicating that the Ethernet ring network is forcedly switched;
clearing the blocked port linked to the RPL; and
flushing an FDB.

5. The forced protection switching method of claim 4, wherein the receiving of the FS message comprises receiving the FS message from one node of the Ethernet ring network that has received a FS command.

6. The forced protection switching method of claim 4, wherein the receiving of the FS message comprises receiving the FS message periodically, and clearing of the port and flushing of the FDB are performed only when the FS message is received for the first time.

7. A forced protection switching method applied in a node of an Ethernet ring network, comprising:
receiving a FS message indicating that the Ethernet ring network is forcedly switched; and
flushing an FDB.

8. The forced protection switching method of claim 7, wherein the receiving of the FS message comprises receiving the FS message from one node of the Ethernet ring network that has received a FS command.

9. The forced protection switching method of claim 7, wherein the receiving of the FS message comprises receiving the FS message periodically, and clearing of the port and flushing of the FDB are performed only when the FS message is received for the first time.

10. A forced protection switching clearing method applied in a node of an Ethernet ring network that has been forcedly switched, comprising:
receiving a FS clear command from an operator;
forwarding bidirectionally in the Ethernet ring network, a clear message indicating that the node has been cleared of being forcedly switched;
receiving a return message indicating that a port linked to an RPL of the Ethernet ring network has been blocked;
clearing a blocked port of the node; and
flushing an FDB.

11. The forced protection switching clearing method of claim 10, wherein the receiving of the return message comprises receiving the return message periodically, and clearing of the blocked port and flushing of the FDB are performed only when the return message is received for the first time.

12. A forced protection switching clearing method applied in a node of an Ethernet ring network whose port is linked to an RPL of the Ethernet ring network and is cleared of being blocked, comprising:
receiving a clear message indicating that the Ethernet ring network had been cleared of being forcedly switched;
driving a timer;
when the timer expires, blocking the port that is linked to the RPL;
forwarding a return message indicating that the port linked to the RPL has been blocked; and
flushing an FDB.

13. The forced protection switching clearing method of claim 12, wherein the receiving of the clear message comprises receiving the clear message from one node of the Ethernet ring network that has received a FS clear command.

14. A forced protection switching clearing method applied in a node of an Ethernet ring network, comprising:
receiving a clear message indicating that the Ethernet ring network had been cleared of being forcedly switched;
receiving a return message indicating that a port linked to a RPL of the Ethernet ring network has been blocked; and
flushing an FDB.

15. The forced protection switching clearing method of claim 14, wherein the receiving of the clear message comprises receiving the clear message from one node of the Ethernet ring network that has received a FS clear command.

16. The forced protection switching clearing method of claim 14, wherein the receiving of the return message comprises receiving the return message from a node that is linked to the RPL.

17. The forced protection switching clearing method of claim 14, wherein the receiving of the return message comprises receiving the return message periodically, and flushing of the FDB comprises flushing the FDB only when the return message is received for the first time.

18. A non-transitory computer-readable recording medium having embodied thereon a computer program for executing the method of claim 1.
